(19) United States
(12) Patent Application Publication
(10) Pub. No.: US 2004/0100665 A1
(43) Pub. Date: May 27, 2004

(54) Video picture scanner

(76) Inventor: Marlow Leonard Bates, Jessup, MD (US)

Correspondence Address: Marlow L. Bates Sr, #195-027, P.O. Box 534 M.H.C-X, Jessup, MD, 20794, US

(21) Appl. No.: 10/244,849

(22) Filed: Nov. 27, 2002

(51) Int. Cl. H04N 1/04

(52) U.S. Cl. 358/479; 358/486

(57) ABSTRACT

The name of this invention is called the “VIDEO PICTURE SCANNER” What makes this Machine so unique is that it can copy the image that you stop it on shown on your TV screen that's coming from your Pause TV, Video and/or DVD. When you want to pull a image from off your monitor, all you have to do is Dress Fast Forward or Rewind until you get to the image that you want. Then press pause and then push the “PICTURE COPY” (button), then your copy of that image will come out from the top of the Picture Scanner. You will then have the PICTURE of the Particular image you want from off the Pause TV. Video and/or DVD. The Picture Scanner can be either made into the video machine or made separately. The Picture Scanner top opens and closes so that you can put the copying paper into the machine one at a time, or it can be made to copy more then one.

### CROSS-REFERENCE TO RELATED APPLICATIONS

SHORT FORM VA/VAu 557-873/MAY 1, 2002

A portion of the disclosure of this patent document contains material to which a claim for copyright is made. The copyright owner has no objection to the facsimile reproduction by anyone of the patent document or the patent disclosure, as it appears in the Patent and Trademark Office patent file or records, but reserves all other copyrights whatsoever.

### STATEMENT REGARDING FRDERALLY SPONSORED RESEARCH OR DEVELOPMENT

Not Applicabl

### REFERENCE TO A MICROFICHE APPENDIX

Not Applicable

### BACKGROUND OF THE INVENTION

This invention relates to video machine and computers. People no longer have to watch the Pause TV, Video and/or DVD and wish that they could get a picture of a Person, Place or things. Because with this invention you can have the all. What makes this “VIDEO PICTURE SCANNER” Machine so unique is that it can copy the image that you stop it on, that is shown on your TV screen; that's coming from your: Pause TV, Video and/or DVD.

### BRIEF SUMMARY OF THE INVENTION

The name of this invention is called the “VIDEO PICTURE SCANNER” What makes this Machine so unique is that it can copy the image that you stop it on shown on your TV screen that's coming from your Pause TV, Video and/or DVD. When you want to pull a image from off your monitor, all you have to do is press Fast Forward or Rewind until you get to the image that you want. Then press pause and then push the “PICTURE COPY” (button), then your copy of that image will come out from the top of the Picture Scanner. You will then have the PICTURE of the Particular image you want from off the video. The Picture Scanner can be either made into the video machine or made separately. The Picture Scanner top opens and closes so that you can put the copying paper into the machine one at a time, or it can be made to copy more then one.

### BRIEF DESCRIPTION OF THE SEVERAL VIEWS OF THE DRAWING

FIG. 1 is a perspective view of the presently preferred embodiment of Video Picture Scanner in position on the TV showing my new design;

FIG. 2 is a front and top elevational showing the Video Picture Scanner Case shut, view thereof;

FIG. 3 is a front and top elevational showing the Case haft way open showing the picture about to come out, view thereof;

FIG. 4 is a front and top elevational showing the case all the way open showing the finish picture inside the machine, view thereof and,

FIG. 5 is a front of the finish picture view thereof.

### DETAILED DESCRIPTION OF THE INVENTION

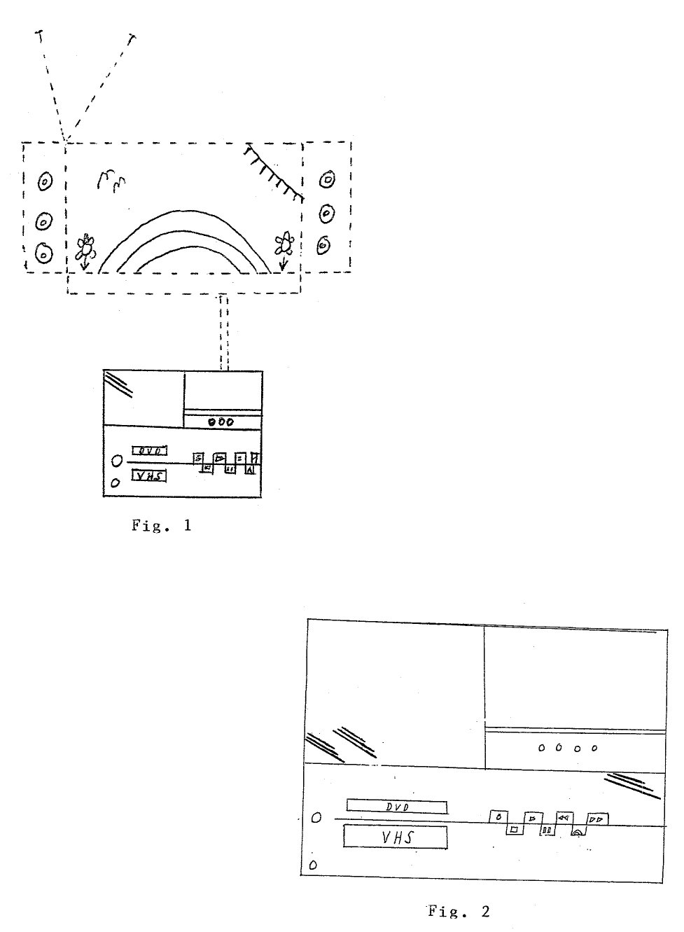

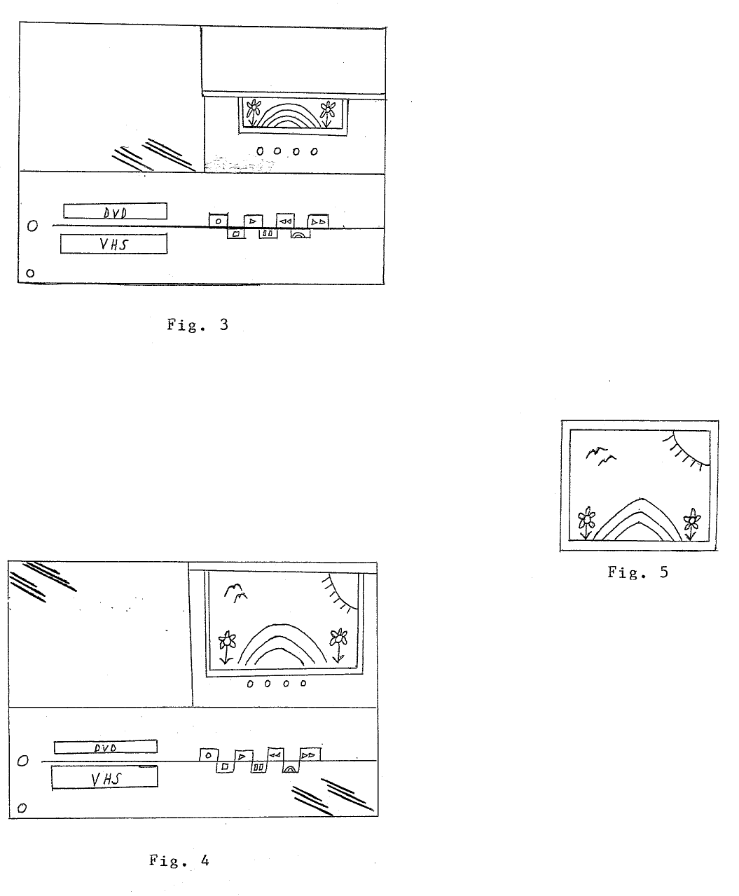

FIG. 1 is a perspective view of the presently preferred embodiment of Video Picture Scanner in position on the TV showing my new design; FIG. 2 is a Showing the case is close where the picture goes in and comes out. FIG. 3 is showing the case haft way open, showing haft of the finish picture that's about to come out from the machine. FIG. 4 is showing the case all the way open and the finish picture that is ready to come out the machine. FIG. 5 is a showing the finish picture that came out from the Video Picture Scanner.

1. What I claim as my invention is a VIDEO PICTURE SCANNER as set forth in the following specification. The claimed VIDEO PICTURE SCANNER is used for Particular image you want from off your: Purse TV's, Videos and/or DVD's.
